(19) United States
(12) Patent Application Publication
(10) Pub. No.: US 2008/0131599 A1
(43) Pub. Date: Jun. 5, 2008

(54) METHOD AND APPARATUS FOR MAKING COATING FILM

(75) Inventors: Yasuhiko Sato, Yokkaichi (JP); Tadahito Fujisawa, Yokkaichi (JP); Kenji Hayashi, Yokkaichi (JP); Yohei Ozaki, Suzuka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/940,762

(22) Filed: Nov. 15, 2007

(30) Foreign Application Priority Data
Nov. 16, 2006 (JP) 2006-310416

(51) Int. Cl. B05D 3/12; B05C 11/02

(52) U.S. Cl. 427/240; 118/52

(57) ABSTRACT

A method of forming a coating film includes dropping a first chemical onto a substrate to be treated and rotating the substrate, thereby forming a first coating film, the first chemical being comprised of a solvent and a solid added to the solvent, baking the first coating film, dropping a second chemical onto a first-chemical poorly-coated region of the stationary substrate, thereby forming a second coating film, the second chemical being comprised of a solvent and a solid added to the solvent, drying the second coating film, and baking the second coating film.

### CROSS-REFERENCE TO RELATED APPLICATIONS

This application is based on and claims the benefit of priority from the prior Japanese Patent Application No. 2006-310416, filed on Nov. 16, 2006, the entire contents of which are incorporated herein by reference.

### BACKGROUND OF THE INVENTION

1. Field of the Invention

The present invention relates to a method and an apparatus for making a coating film used in a coating film forming step in a semiconductor fabricating process such as a wafer step or an exposure mask fabricating step or a liquid crystal device making process.

2. Description of the Related Art

For example, a process of fabricating a semiconductor device includes a multiple of steps of depositing a plurality of film materials on a silicon substrate serving as a substrate to be treated and patterning the deposition into a desired pattern. In the patterning step, a photosensitive material referred to as “photoresist” is deposited on the treated material on the silicon substrate. The photoresist is selectively exposed to light. Photoresist liquid is dropped from a nozzle of a chemical dispenser onto the surface of the silicon substrate rotated at high speeds, thereby being formed into a resist film with a necessary film thickness. JP-A-2004-103781 discloses one of the above-described techniques.

Diameters of the silicon substrates serving as the substrate to be treated have recently been increased. Accordingly, conventional spin coating methods cannot sufficiently spread the coated chemical. As a result, notches and bevels include uncoated parts. Thus, it has been difficult to form a film having a desired film thickness on a whole surface of the silicon substrate.

### BRIEF SUMMARY OF THE INVENTION

Therefore, an object of the present invention is to provide a method and apparatus for reliably forming a coating film with a predetermined film thickness on a whole surface of the substrate to be treated.

In one aspect, the present invention provides a method of forming a coating film, comprising dropping a first chemical onto a substrate to be treated and rotating the substrate, thereby forming a first coating film, the first chemical being comprised of a solvent and a solid added to the solvent, baking the first coating film, dropping a second chemical onto a first-chemical poorly-coated region of the stationary substrate, thereby forming a second coating film, the second chemical being comprised of a solvent and a solid added to the solvent, drying the second coating film, and baking the second coating film.

In another aspect, the invention provides a coating film forming apparatus comprising a substrate mount on which a substrate to be treated is placed, a driver capable of rotating the substrate mount with the substrate being placed on the substrate mount, a first drop nozzle dropping a first chemical onto the substrate placed on the substrate mount, a second drop nozzle dropping a second chemical, a mover capable of controlling the second drop nozzle so that the second drop nozzle is movable relative to the substrate mount, and a suction nozzle sucking in air near to a surface of the substrate placed on the substrate mount, thereby carrying out a drying treatment.

### BRIEF DESCRIPTION OF THE DRAWINGS

Other objects, features and advantages of the present invention will become clear upon reviewing the following description of one embodiment with reference to the accompanying drawings, in which:

FIGS. 1A and 1B are views showing a frame format of a coating film forming apparatus of one embodiment in accordance with the present invention;

FIGS. 2A and 2B are plan views of a silicon substrate, showing a notch; and

FIGS. 3A and 3B are sectional view of a silicon substrate, showing a bevel.

### DETAILED DESCRIPTION OF THE INVENTION

One embodiment of the present invention will be described with reference to the accompanying drawings. The invention is applied to a case where a coating film of chemical such as resist is formed on a semiconductor substrate serving as a substrate to be treated.

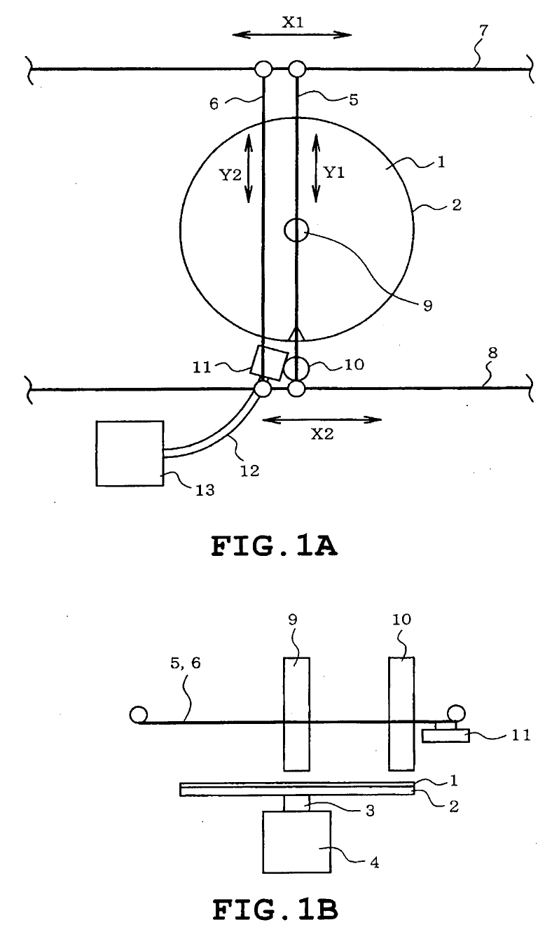

FIGS. 1A and 1B show a schematic construction of the coating film forming apparatus. FIG. 1A is a top plan view of the apparatus, whereas the FIG. 1B is a side view of the apparatus. A silicon substrate 1 which is a silicon wafer serves as a substrate to be treated in the invention. The silicon substrate 1 is placed on a spin chuck 2 which is a generally circular mount corresponding to the size of the silicon substrate 1 having a diameter of 30 cm, for example. The spin chuck 2 has an underside mounted with a centrally located rotational shaft 3 which is rotatably coupled to a rotational shaft of an electric motor 4. First and second arms 5 and 6 are provided over the spin chuck 2 so as to extend across the spin chuck 2 in a vertical direction as viewed in FIG. 1A (in Y1 and Y2 direction). Each of the arms 5 and 6 has both ends connected to guide rails 7 and 8 extending in the direction perpendicular thereto (in the X1 and X2 direction as viewed in FIG. 1A). The first and second arms 5 and 6 are capable of parallel movement along the guide rails 7 and 8 in the X1 and X2 direction.

A first nozzle 9 is provided above the spin chuck 2 so as to correspond to the spin chuck center. The first nozzle 9 is capable of dropping a first chemical. The first nozzle 9 is set so as to drop a coating liquid as the first chemical onto the spin chuck 2. The coating liquid is adjusted for use with a spin coat. A second nozzle 10 is mounted on the first arm 5 so as to be reciprocable in the Y1 direction. The second nozzle 10 is capable of dropping a second chemical. The second nozzle 10 is set so as to drop, as the second chemical, a coating liquid which is adjusted so that a predetermined amount of coating liquid is spread during dropping.

A suction nozzle 11 is mounted on the second arm 6 so as to be reciprocable in the Y2 direction. The suction nozzle 11 is disposed so that a suction opening (not shown) thereof faces an upper surface of the spin chuck 2. An elevating tube 12 is connected to the suction nozzle 11 and further to the suction port side of a vacuum pump 13. Upon operation of the vacuum pump 13, air is drawn via the elevating tube 12 from the suction nozzle 11. As a result, since air near to the surface of the silicon substrate is moved toward the suction nozzle 11, the surface of silicon substrate 1 located both beneath and around the suction nozzle 11 can be dried.

Next, a photolithography process will be described. In the photolithography process, a photoresist and an antireflective coating are usually coated on the silicon substrate 1, then baked and exposed to light. A processing procedure is then carried out such that a resist pattern is formed. Furthermore, a photoresist film is formed on the surface of the silicon substrate 1 in the photolithography process employing a liquid immersion exposure method. Under this condition, a space between a lens of exposure system and the photoresist film is filled with a liquid such as water for execution of exposure. Accordingly, in order that photoresist composition may be prevented from elution in water for prevention of contamination of the lens, a protecting film needs to be formed on the photoresist. Consequently, in the aforesaid liquid immersion exposure method, for example, an antireflective coating and photoresist are coated and thereafter, a protective film is coated. Subsequently, the liquid immersion exposure is carried out. A baking treatment is normally executed after each film is coated.

In the chemical coating, firstly, the silicon substrate 1 is placed on the spin chuck 2 as a first coating film forming step. A predetermined amount of the first chemical is dropped from the first nozzle 9 onto the central part of the substrate 1 while the spin chuck 2 is rotated at high speeds by the motor 4. The first chemical includes a solvent and solid content added to the solvent. An amount of the first chemical dropped ranges from 0.01 to 30 cc, or more preferably, from 0.1 to 10 cc. A lower limit (0.01 cc) is determined so that a discharge rate is not excessively small and a coating film can be spread over the entire surface of the substrate 1. An upper limit (30 cc) is determined so that an amount of the chemical uncoated on the substrate 1 is proper and efficient. Furthermore, a drop position of the first chemical is set to be within a 1-cm radius with respect to a rotation center of the substrate 1, and a range is desirable in which the first chemical is dropped onto the substrate 1 to be formed into a film with a uniform film thickness.

The first nozzle 9 need not be usually positioned over the substrate 1 and may be moved over the substrate 1 only when the first chemical is dropped. A rotational speed of the spin chuck 2 ranges, for example, from 100 to 20000 rpm or more preferably, from 500 to 7000 rpm. In this case, when the rotational speed of the spin chuck is set in the range from 500 to 7000 rpm, the first chemical can be spread uniformly over the substrate 1 and a uniform film quality can be achieved without occurrence of turbulence airflow around the substrate 1.

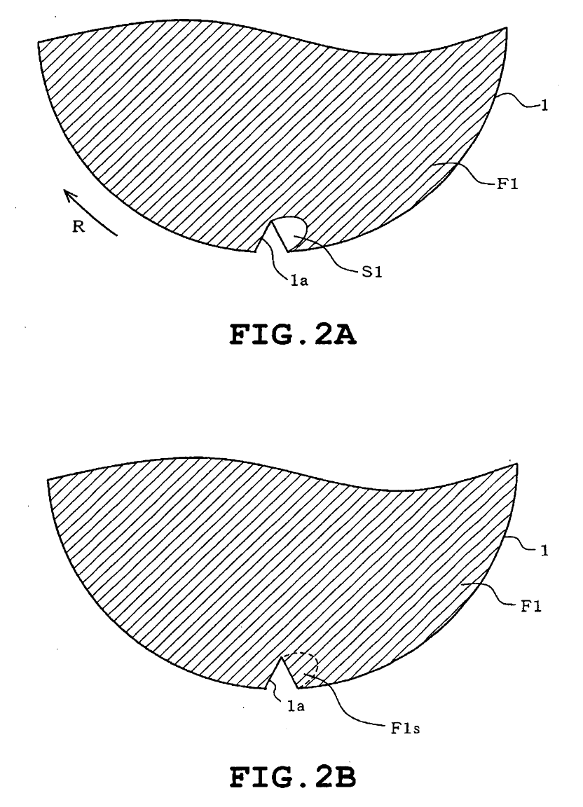

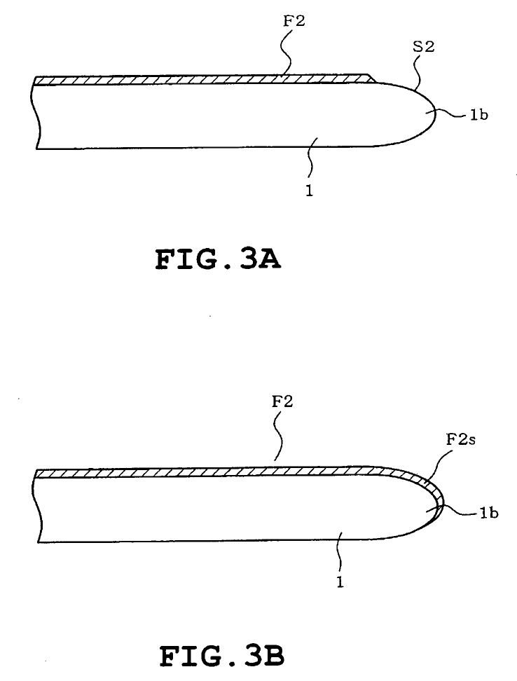

Subsequently, a second coating film forming step will be described. In the first coating film forming step, the first coating film cannot sometimes be formed over the entire coating surface of the substrate 1. For example, the first coating film cannot sometimes be formed on a notch 1a of the substrate 1 as shown in FIG. 2A or a chamfered bevel 1b formed on an outer peripheral side of the substrate 1 as shown in FIG. 3A. When spin coating is carried out in the first coating film forming step, the first coating film is not sometimes formed on the notch 1a or the bevel 1b exactly due to a shape or surface condition of the notch or bevel. In this case, recoating results in an increase in the number of steps. The second coating film forming step is carried out to compensate for the first coating film forming step.

A second chemical is adjusted so as to spread over the substrate 1 by a predetermined amount in the second coating film forming step. The second chemical comprises a solvent and solid content added to the solvent and is dropped from the drop nozzle 10 so that a liquid film is formed on a part of the substrate. The solvent and solid content of the second chemical is normally the same as the solvent and solid content of the first chemical. However, a solvent and solid content different from the first chemical may be used for the second chemical. Furthermore, the second drop nozzle 10 may be the same as the first drop nozzle 9 used in the first coating film forming step or may differ from the first drop nozzle 9. The nozzles should not be limited to a particular shape but may have a circular opening or may be a slit nozzle which has a slit-like opening. In this case, an amount of second chemical to be discharged may range from 0.001 to 30 cc. The range ensures spread of a coating film to a predetermined region and prevents supply of an excessive amount of the second chemical. The second drop nozzle 10 may or may not be located immediately above the substrate 1. The second drop nozzle 10 may be located obliquely above the substrate 1. A distance between the location of the second drop nozzle 10 and a region where the coating film may range from 0.01 to 5.00 cm or more preferably from 0.1 to 1.0 cm.

Describing a method of forming the second coating film, the second chemical is sprayed out of the second drop nozzle 10 so that a predetermined amount of the second chemical is spread, whereby the second coating film is formed. Alternatively, the second chemical is dropped from the drop nozzle 10 and thereafter, the second chemical is supplied while the substrate 1 is moved relative to the second drop nozzle 10, whereby a predetermined amount of second chemical can be spread onto a predetermined region. When the second coating film is formed with relative movement of the substrate 1, either the second drop nozzle 10 or substrate 1 may be moved or both of the second drop nozzle 10 and substrate 1 may be moved.

Furthermore, a baking treatment is carried out after the film coating step. In this case, the baking treatment may be carried out individually in the first and second coating film forming steps. Alternatively, the baking treatment may be carried out after both the first and second coating films have been formed.

Several examples in each of which the first and second coating films are formed will now be described with reference to FIGS. 2A to 3B.

### EXAMPLE 1

In example 1, a silicon wafer having a diameter of 300 mm is employed as the silicon substrate 1. A photoresist coating film F1 serving as the coating film is formed. In this case, a coating failure region S1 occurs in the notch 1a. In the first coating film forming step, the first coating film or a chemically amplified positive resist SIAL-X125 manufactured by Shin-Etsu Chemical Co., Ltd. is dropped by 1 cc through the first drop nozzle 9 with a circular opening having a diameter of 2 mm onto the central part of the substrate 1. A distance between the surface of the substrate 1 and the first drop nozzle 9 is 1 cm during the dropping. The spin chuck 2 is then rotated at a rotational speed of 1000 rpm by the motor 4 so that the substrate 1 is rotated. As a result, the centrifugal force spreads the resist toward the outer peripheral side, whereby the first coating film F1 is formed.

FIG. 2A shows the first coating film F1 which is formed substantially an overall surface of the substrate 1. However, the photoresist cannot sometimes be coated on a rear side of the notch 1a with respect to a rotational direction R reliably, whereupon a defective coating region S1 occurs. The second coating film forming step is carried out in order that resist may reliably be coated on the defective part. In the second coating film forming step, 0.1 cc of resist serving as a second chemical (coating liquid) is sprayed from the second drop nozzle 10 with a circular opening having a diameter of 2 mm so that a second coating film F1s is formed on the defective region S1 of the stationary substrate 1 as shown in FIG. 2B. The second coating film F1s is then dried using the suction nozzle 11 in the second coating film forming step. In this case, the arm 6 is moved along the guide rails 7 and 8, and the suction nozzle 11 is controlled so as to be moved to the region where the second coating film F1s along the arm 6. Subsequently, a baking treatment is carried out for the substrate 1 at 125° C. for 60 seconds, whereupon a resist film having a uniform film thickness can be obtained on the surface of the substrate 1.

There is a possibility that pinholes may be formed in the resist film when the baking treatment is carried out without drying the liquid resist. In view of the problem, the drying treatment is carried out using the suction nozzle 11 after the second chemical has been coated on the stationary substrate 1. The first chemical is dried by the rotation of the substrate 1.

### EXAMPLE 2

In example 2, a photoresist coating film F1 is formed as a coating film on the silicon substrate 1 which is a silicon wafer with a diameter of 300 mm in the same manner as described above. A defective coating region S1 occurs in the notch 1a after execution of the baking treatment.

Firstly, a first coating film F1 is formed in the first coating film forming step in the same manner as described in example 1. Subsequently, a baking treatment is carried out for the substrate 1 at 125° C. for 60 seconds (first baking step). After the baking treatment, a defective coating region S1 where no resist is coated sometimes occurs on the notch 1a of the substrate 1. In view of the problem, the second coating film forming step is carried out after the baking treatment of the first coating film F1 in the same manner as in example 1, so that a second coating film F1s is formed on the notch 1a of the stationary substrate 1. Subsequently, the second coating film F1s is dried using the suction nozzle 11 and thereafter, the baking treatment is carried out for the second coating film F1s (second baking step). Consequently, a coating film or resist film is formed on the surface of the substrate 1 with a film thickness being uniform within the substrate surface.

### EXAMPLE 3

In example 3, a photoresist coating film F2 is formed as a coating film on the silicon substrate 1 which is a silicon wafer with a diameter of 300 mm in the same manner as described above. A defective coating region S2 occurs in the bevel 1b.

In the first coating film forming step, a lower layer resist made by dissolving 90-g ethyl lactate in 10-g novolac resin is used as the first chemical. The lower layer resist is dropped by 1 cc through the first drop nozzle 9 with a circular opening having a diameter of 2 mm onto the central part of the substrate 1. A distance between the surface of the substrate 1 and the first drop nozzle 9 is 1 cm during the dropping. Subsequently, the substrate 1 is rotated at 1000 rpm so that a first coating film F2 is formed. FIG. 3A shows the first coating film F2 in the formed state. The first coating film F2 is formed substantially an overall coating surface of the substrate 1. However, the lower layer resist cannot sometimes be coated on the peripheral bevel 1b, whereupon a defective coating region S2 occurs. The second coating film forming step is carried out in order that resist may reliably be coated on the defective part.

In the second coating film forming step, the second drop nozzle 10 with a circular opening having a diameter of 2 mm is moved so as to be located 1 mm above the bevel 1b. The spin chuck 2 is driven to rotate the substrate 1 at 100 rpm one or plural turns while the resist liquid serving as the second chemical is sprayed. When the substrate 1 is rotated at a high speed such as about 1000 rpm, turbulent airflow occurs around the bevel 1b, whereupon it is difficult to form the second coating film F2s. In view of the problem, the rotational speed of the substrate 1 is rotated at a rotational speed lower than during the formation of the first coating film F2 when the second coating film F2s is formed. As a result, the second coating film F2s can reliably be formed on the bevel 1b. Thereafter, the substrate 1 is rotated at 1200 rpm for 30 seconds so that the coating films F2 and F2s are dried. Subsequently, a baking treatment is carried out for the substrate 1 at 125° C. for 60 seconds such that a resist film having a uniform filmthickness can be formed as the coating film.

### Modified Forms:

The second coating film forming step is carried out after the first coating film forming step in each of the foregoing examples. However, for example, the conditions of the coating films F1 and F2 on the substrate 1 may be examined by an appearance check after the first coating film forming step. The second coating film forming step may be carried out only when occurrence of defective coating region S1 or S2 has been confirmed by the appearance check.

The photoresist is used as the chemical in each of the foregoing examples. A positive or negative photoresist may be selected according to a purpose. More specifically, for example, the positive resist may include a resist comprising naphthoquinone diazides and novolac resin (IX-770, manufactured by JSR Corporation, Tokyo) and a chemical amplification resist (APEX-E, manufactured by Shipley Company, LLC, Marlborough) comprising tert-butyloxycarbonyl (t-BOC) protected polyvinylphenol resin and onium salt. Furthermore, for example, the negative resist may include a chemical amplification resist (XP-89131, manufactured by Shipley Company, LLC, Marlborough) comprising polyvinylphenol, a resist (RD-2000D, Hitachi Chemical Co., Ltd., Tokyo) comprising polyvinylphenol and bis-azide compound. The photoresist should not be limited to the above-described. The transparency of a photoresist film may be reduced by adding a dye to the photoresist in order that the dimension control performance of resist pattern may be prevented from being reduced by standing waves produced in a resist film. The dye absorbs ultraviolet light into photosensitive composition and includes coumalin and curcumin.

Furthermore, solvents for the aforesaid resist materials may include acetone, ketonic solvents such as methylethylketon, methyl ethyl ketone, methyl isobutyl ketone and cyclohexane, cellosolvic solvents such as 2-methoxyethanol, ethylene glycol monomethyl ether acetate and ethylene glycol monoethyl ether acetate, ester solvents such as ethyl lactate, ethyl acetate, butyl acetate and isoamyl acetate, alcoholic solvents such as methanol, ethanol and isopropanil, anisol, toruene, xylene and naphtha.

The chemical to be dropped may include an antirefelection coating film agent, protective film used for liquid immersion exposure and oxide film agent, other than photoresist. The protective film used for liquid immersion exposure may further include an alkaline soluble type which is removable when resist is developed using an alkaline developer and a solvent soluble type which needs to be removed using a solvent before the developing treatment of the resist using alkaline developer. The protective film is formed after the coating of resist in each type. A protective film cleaning step may be eliminated before and/or after exposure in the liquid immersion exposure. The alkaline soluble type may include TCX041 manufactured by JSR Corporation, whereas the solvent soluble type may include TSRC002 manufactured by Tokyo Ohka Kogyo Co., Ltd., Tokyo.

The lower layer film may include an antireflection film, an intermediate film of a multilayer resist such as spin-on glass. The lower layer should not be limited to specific material if the material can be formed as a lower layer of resist. When a untireflection film is to be formed, a coating type antireflection film such as AR5 or AR26 manufactured by Rohm and Haas Company, U.S.A. may be used as the chemical.

A chemical may be used as interlayer dielectrics (ILD) serving as an oxide film when the coating oxide film (spin-on glass (SOG)) as a coating film. For example, a HSG film (hydrogenated silsesquioxane) may be used as inorganic SOG film, whereas a MSQ film (methylsilsesquioxane acid) may be used as an organic SOG. Furthermore, a low-k material for low-dielectric-constant interlayer insulating film may include HSG manufactured by Hitachi Chemical Co., Ltd. and HOSP manufactured by Honeywell International Inc., U.S.A. An organic polymer material may include Silk manufactured Dow Chemical Company, U.S.A. and PLARE manufactured by Honeywell International Inc.

Semiconductor substrates other than silicon substrate may be used as the substrate to be treated. The invention may be applied to glass substrates or any other substrates on which a coating film is formed, other than semiconductor substrates. Furthermore, the diameter of the substrate should not be limited to 300 mm. The diameter of the substrate to be treated may take any other value.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A method of forming a coating film, comprising:
dropping a first chemical onto a substrate to be treated and rotating the substrate, thereby forming a first coating film, the first chemical being comprised of a solvent and a solid added to the solvent;
baking the first coating film;
dropping a second chemical onto a first-chemical poorly-coated region of the stationary substrate, thereby forming a second coating film, the second chemical being comprised of a solvent and a solid added to the solvent;
drying the second coating film; and
baking the second coating film.

2. The method according to claim 1, wherein the substrate is rotated at a rotational speed ranging from 100 to 20000 rpm in the first coating film forming step.

3. The method according to claim 1, wherein the substrate is rotated at a rotational speed ranging from 500 to 7000 rpm in the first coating film forming step.

4. The method according to claim 1, wherein an amount of the first chemical dropped ranges from 0.01 to 30 cc in the first coating film forming step.

5. The method according to claim 1, wherein an amount of the first chemical dropped ranges from 0.1 to 10 cc in the first coating film forming step.

6. The method according to claim 1, wherein a drop position of the first chemical is set to be within a 1-cm radius with respect to a rotation center of the substrate in the first coating film forming step.

7. The method according to claim 1, wherein an amount of the second chemical dropped ranges from 0.001 to 30 cc in the second coating film forming step.

8. The method according to claim 1, wherein a drop position of the second chemical dropped onto a surface of the substrate ranges from 0.01 to 5.00 cm in the second coating film forming step.

9. The method according to claim 1, wherein a drop position of the second chemical dropped onto a surface of the substrate ranges from 0.1 to 1.00 cm in the second coating film forming step.

10. A method of forming a coating film, comprising:
dropping a first chemical onto a substrate to be treated and rotating the substrate at a first rotational speed, thereby forming a first coating film, the first chemical being comprised of a solvent and a solid added to the solvent; and
dropping a second chemical onto a bevel region of the substrate and rotating the substrate at a second rotational speed lower than the first rotational speed, thereby forming a second coating film, the second chemical being comprised of a solvent and a solid added to the solvent.

11. The method according to claim 10, wherein the substrate is rotated at a rotational speed ranging from 100 to 20000 rpm in the first coating film forming step.

12. The method according to claim 10, wherein the substrate is rotated at a rotational speed ranging from 500 to 7000 rpm in the first coating film forming step.

13. The method according to claim 10, wherein an amount of the first chemical dropped ranges from 0.01 to 30 cc in the first coating film forming step.

14. The method according to claim 10, wherein an amount of the first chemical dropped ranges from 0.1 to 10 cc in the first coating film forming step.

15. The method according to claim 10, wherein a drop position of the first chemical is set to be within a 1-cm radius with respect to a rotation center of the substrate in the first coating film forming step.

16. The method according to claim 10, wherein an amount of the second chemical dropped ranges from 0.001 to 30 cc in the second coating film forming step.

17. The method according to claim 10, wherein a drop position of the second chemical dropped onto a surface of the substrate ranges from 0.01 to 5.00 cm in the second coating film forming step.

18. The method according to claim 10, wherein a drop position of the second chemical dropped onto a surface of the substrate ranges from 0.1 to 1.00 cm in the second coating film forming step.

19. The method according to claim 10, wherein the second rotational speed is set at 100 rpm in the second coating film forming step.

20. A coating film forming apparatus comprising:
a mounting portion mounting a substrate to be treated;
a rotating portion rotating the mounting portion;
a first drop nozzle dropping a first chemical onto the substrate placed on the mounting portion;
a second drop nozzle dropping a second chemical onto the substrate placed on the mounting portion, the second drop nozzle being movable relative to the substrate placed on the mounting portion; and
a suction nozzle sucking in air near to a surface of the substrate placed on the mounting portion, thereby carrying out a drying treatment.
